(19) United States
(12) Patent Application Publication
(10) Pub. No.: US 2013/0098528 A1
(43) Pub. Date: Apr. 25, 2013

(54) METHODS AND APPARATUS FOR CONTROLLING EXCESS FIBER LENGTH (EFL) IN ARMORED CABLE

(71) Applicant: WEATHERFORD/LAMB, INC., Houston, TX (US)

(72) Inventors: Edward M. Dowd, Madison, CT (US); Domino Taverner, Wallingford, CT (US); John J. Grunbeck, Northford, CT (US)

(73) Assignee: WEATHERFORD/LAMB, INC., Houston, TX (US)

(21) Appl. No.: 13/656,135

(22) Filed: Oct. 19, 2012

Related U.S. Application Data
(60) Provisional application No. 61/549,137, filed on Oct. 19, 2011.

(51) Int. Cl. B29C 70/16

(52) U.S. Cl. 156/64; 156/378

(57) ABSTRACT

Certain aspects of the present disclosure provide techniques and corresponding apparatus for making armored cables with optical fibers contained therein. The techniques may be utilized to control an amount of excess fiber length (EFL) in the armored cables. The techniques may also allow introduction of optical fibers directly into a welding process without using an inner tube in the final armored cable.

### CLAIM OF PRIORITY UNDER 35 U.S.C. §119

The present Application for Patent claims priority to U.S. Provisional Application No. 61/549,137, filed Oct. 19, 2011, and assigned to the assignee hereof and hereby expressly incorporated by reference herein.

### BACKGROUND

1. Field

Aspects of the present disclosure generally relate to fabricating an armored cable having one or more optical fibers contained therein. More particularly, aspects of the present disclosure relate to controlling an amount of excess fiber length (EFL) of the one or more optical fibers within the armored cable.

2. Description of the Related Art

Downhole optical fiber cables are often manufactured using an outer armor for protection of one or more optical fibers contained therein. It is often desirable to have some amount of excess fiber length (EFL) in the armored cable, for example, to reduce strain on the optical fibers. EFL generally refers to an excess length of the fiber relative to the outer armor.

The outer armor may typically be formed by seam welding the outer armor over another (inner) tube that contains the optical fibers. The inner tube may protect the optical fiber from the extreme heat generated during the welding process. However, the use of an inner tube adds substantial cost to the armored cable.

In some cases, the optical fiber(s) may be put into an armor tube after the tube is manufactured by pushing fiber into the tube with the aid of gas or liquids. Unfortunately, this is a costly and time-consuming process and, in addition, it is difficult to achieve a desired amount of EFL.

For example, one or more optical fibers may be pushed into a metal tube when manufacturing a fiber in metal tube (FIMT), as described in U.S. Pat. No. 7,024,081 to Dowd et al., herein incorporated by reference in its entirety. During fabrication of a FIMT, the metal strip stock may be fed into the forming rollers which then pull the strip along as the strip is formed into a tube and welded at the seam. The tube may be welded somewhat larger in diameter than the finished tube size at this point. The optical fibers and gel material (if used) may be fed through guide tubes parallel to the strip stock and past the welding zone. The optical fibers are not pushed into the guide tubes; rather, the fibers get caught in the seam-welded metal tube by friction and are pulled at low tension from payoff spools through the guide tubes and into the metal tube. If gel is used, it will aid in pulling the fibers and can also have limited control of the overstuff, based on gel pumping volume. After welding, while still on the line, the assembly may be pulled through a sizing die to form the final FIMT diameter. A capstan may be located downstream of the die. The force involved in pulling the oversized tube through the die also stretches the tube, pulling extra fiber in from the fiber payoff spool. When the FIMT exits the capstan, the tension is reduced, and the FIMT has a small relax in length, yielding fiber overstuff. This method may be difficult to accomplish with ¼″ heavy wall cable.

As an alternative, fiber overstuff may be added to the tube by running it through a series of rollers, which works the metal and effectively shrinks the length of the tube. This alternative method can be used for larger tubes, like ¼″, but is limited in the amount of overstuff that can be achieved and also entails extra processing.

### SUMMARY

Certain aspects of the present disclosure provide techniques and corresponding apparatus for making armored cables with optical fibers contained therein. The techniques may be utilized to control an amount of EFL in the armored cables. The techniques may also allow introduction of optical fibers directly into a welding process without using an inner tube in the final armored cable.

Certain aspects of the present disclosure provide an apparatus for making an armored cable. The apparatus generally includes means for determining an excess fiber length (EFL) parameter indicative of a desired EFL for one or more optical fibers in armor tubing of the armored cable and means for controlling at least one of a rate at which the one or more optical fibers are fed into a process for forming the armor tubing or a rate at which material for forming the armor tubing is fed into the process for forming the armor tubing, based at least in part on the EFL parameter.

Certain aspects of the present disclosure provide a method for making an armored cable. The method generally includes determining an EFL parameter indicative of a desired EFL for one or more optical fibers in armor tubing of the armored cable and controlling at least one of a rate at which the one or more optical fibers are fed into a process for forming the armor tubing or a rate at which material for forming the armor tubing is fed into the process for forming the armor tubing, based at least in part on the EFL parameter.

Certain aspects of the present disclosure provide an apparatus for making an armored cable. The apparatus generally includes a controller configured to determine an EFL parameter indicative of a desired EFL for one or more optical fibers in armor tubing of the armored cable and to control at least one of a rate at which the one or more optical fibers are fed into a process for forming the armor tubing or a rate at which material for forming the armor tubing is fed into the process for forming the armor tubing, based at least in part on the EFL parameter.

### BRIEF DESCRIPTION OF THE DRAWINGS

So that the manner in which the above recited features of the present disclosure can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a technique of making an armored cable, in accordance with one aspect of the present disclosure.

FIG. 2 illustrates a technique of making an armored cable using a banded tractor feed mechanism as a fiber feed mechanism, in accordance with one aspect of the present disclosure.

FIG. 3 illustrates an example control algorithm for controlling excess fiber length (EFL) when making an armored cable, in accordance with one aspect of the present disclosure.

FIG. 4 illustrates an example cross-sectional view of a single optical fiber in a fiber guide tube in the welding zone for forming a seam welded armor tube, in accordance with one aspect of the present disclosure.

FIG. 5 illustrates an example cross-sectional view of multiple optical fibers in a fiber guide tube in the welding zone for forming a welded armor tube, in accordance with one aspect of the present disclosure.

FIG. 6 illustrates an example cross-sectional view of optical fiber in a fiber guide tube, surrounded by an outer guide tube, in the welding zone for forming a welded armor tube, in accordance with one aspect of the present disclosure.

FIG. 7 illustrates an example cross-sectional view of optical fibers in multiple fiber guide tubes, surrounded by an outer guide tube, in the welding zone for forming a welded armor tube, in accordance with one aspect of the present disclosure.

FIG. 8 is a flow diagram of example operations for controlling processing rates during fabrication of an armored cable, in accordance with one aspect of the present disclosure.

### DETAILED DESCRIPTION

Certain aspects of the present disclosure provide techniques and corresponding apparatus for fabricating armored cables with optical fibers contained therein. The techniques may help overcome process difficulties, including control of excess fiber length (EFL) in a finished armored cable and protecting optical fibers from the extreme heat generated during the welding process.

As described herein, the techniques may allow fibers to be introduced directly into an armor tubing during a seam welding process, while eliminating the use of an inner tube surrounding the fibers in the final armored cable. A desired EFL may be maintained by adjusting a feed rate of the optical fiber(s), during the welding process, as a function of the desired EFL and a feed rate of the armor tubing.

With many cable designs, a smaller inner tube may already contain the EFL and also acts as a shield for protecting the fibers from the heat of armor tube welding. If the inner tube is made of metal, it is of relatively thin wall, so its manufacture requires relatively low energy to weld with less possibility of damaging the optical fibers. The EFL of an inner tube is generally produced by means of elongation and relaxation of the tube length in the process line of fabricating the tube. Controlled pumping of a filler gel with the fibers may also be used as an aid to produce EFL. This fiber containing inner tube is then introduced to the armor tube during the armor tube welding seam welding process.

Unfortunately, these approaches may not be suitable for manufacturing a cable with optical fibers protected within a relatively thick walled armor tube, as is commonly used in downhole applications (e.g., to interrogate downhole optical sensors and/or perform distributed sensing operations).

According to aspects of the present disclosure, one approach to manufacturing a cable consisting of optical fibers within a heavy walled armor tube (with no inner tube) is to feed (e.g., push) the optical fibers into the armor tube during the tube welding process (e.g., as the armor tube is being formed by welding or some other process).

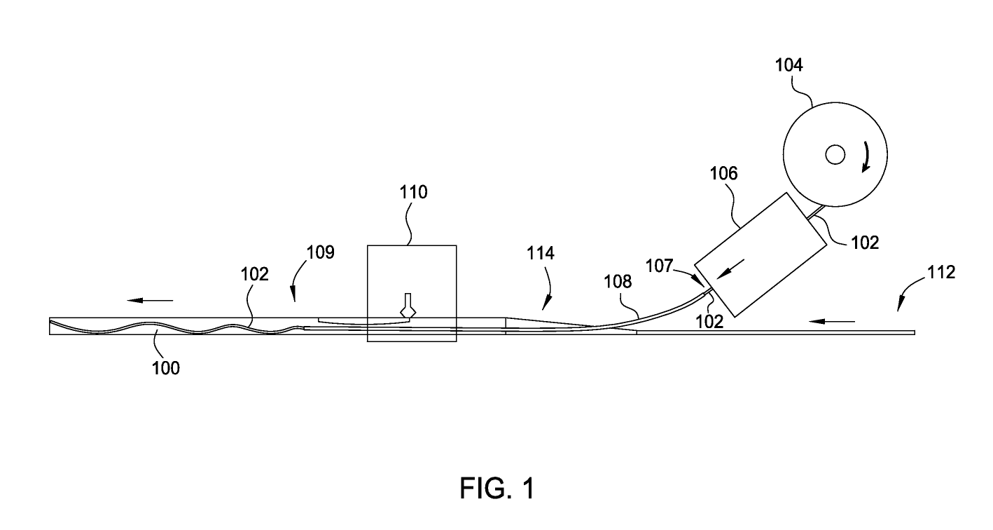

FIG. 1 illustrates fabrication of an armored cable, in accordance with one aspect of the present disclosure. The armored cable comprises an armor tube 100 and one or more optical fibers 102 (only one optical fiber is illustrated in FIG. 1 for simplicity). To form the armor tube 100, flat tube strip stock at 112 may be fed to a tube forming stage 114, which gradually rolls up the sides of the tube strip stock into a tube as the tube strip stock moves through the process at a particular tube rate. The seam (which may be a ¼ in. seam) in the nearly completed tube is then welded in the welding zone 110 to form a completed, seam-welded armor tube.

Protection of the fibers 102 from the armor tube welding process may be provided by using guide tubes 108. The fiber guide tubes 108 may be made of metal, ceramic, or any of various other suitable heat-resistant materials. The guide tubes 108 may be fixed in position in the welding zone 110, perhaps at least at or near the welding point. The guide tube's fiber entrance 107 may be located (just) before or in the armor tube's tube forming stage 114. The guide tube's fiber exit 109 may be disposed inside the welded armor tube, beyond a point at which heat from welding would damage the fibers.

The amount of EFL in the finished armored cable may be controlled by the ratio of the fiber pushing speed to the tube welding line speed (e.g., the ratio of these feed rates generally determines the amount of EFL). The fiber 102 is pushed through the guide tube 108 with a fiber feed device 106, a mechanism that can feed the fiber from a fiber source 104 at a controlled rate. The EFL can then be managed by controlling the fiber's feed rate as compared to the armor tube welding line speed (i.e., the tube rate).

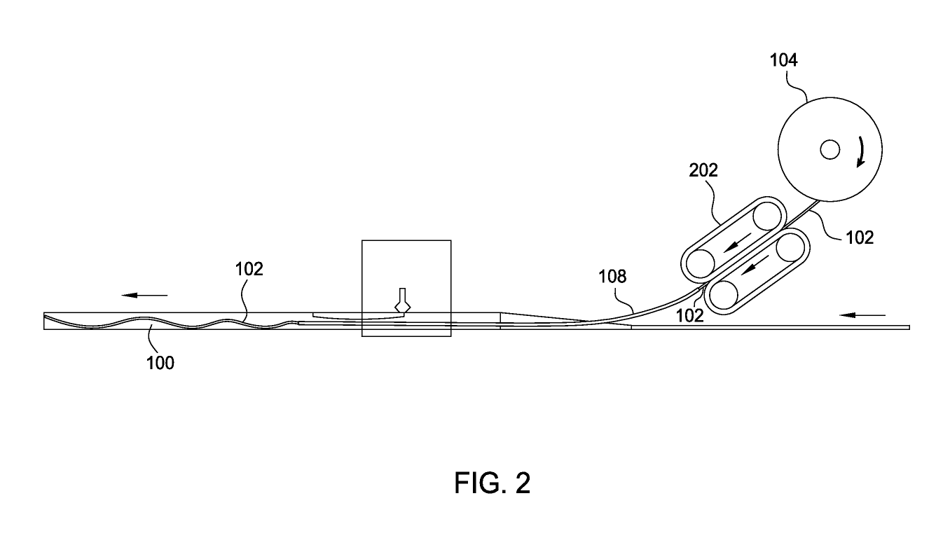

As illustrated in FIG. 2, the mechanism that feeds fibers into the guide tubes may be a banded tractor feed mechanism 202 for pulling the fibers from the fiber source 104 (e.g., one or more spools) and pushing the fibers into the guide tubes 108. Alternatively, a roller/capstan, a gas venturi, or any other device that can push the fibers into the guide tubes 108 may be used as a feed mechanism. Pumping a viscous gel material inside the fiber guide tube 108 will also feed fiber into the armor tube process.

The optical fiber 102 may be composed of any of various suitable materials, such as glasses and/or plastics (e.g., silica, phosphate glass, glass and plastic, or solely plastic). Also, a multi-mode, birefringent, polarization-maintaining, polarizing, multi-core, flat or planar (where the optical waveguide is rectangular shaped), or other optical waveguide may be used if desired. The fiber or waveguide may contain sensors within it (e.g., laser written directly) or attached to it (e.g., spliced), including Bragg grating type sensors.

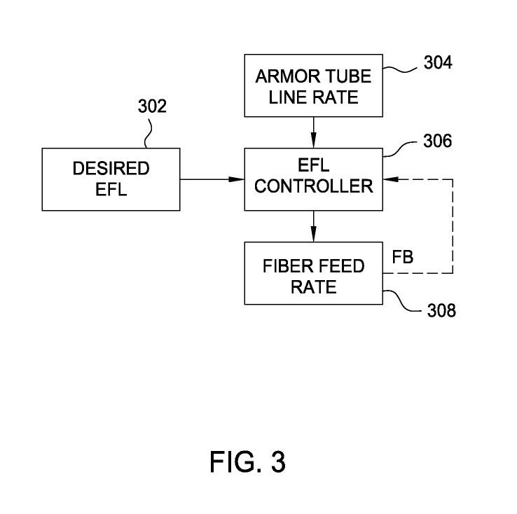

FIG. 3 illustrates an example control algorithm for controlling excess fiber length (EFL) when making an armored cable, in accordance with one aspect of the present disclosure. As illustrated, an EFL controller 306 may control the fiber feed rate 308 (i.e., the rate at which the optical fibers are fed into the process for forming the armor tubing) based on a desired EFL 302 and the armor tube line rate 304 (i.e., the rate at which material for forming the armor tubing is fed into the formation process). As noted above, more generally, the EFL controller may control the ratio of the feed rates 304 and 308 to achieve the desired EFL 302. For certain aspects, as illustrated in FIG. 3, the actual fiber feed rate 308 may be fed back to the EFL controller 306, for a closed loop control algorithm.

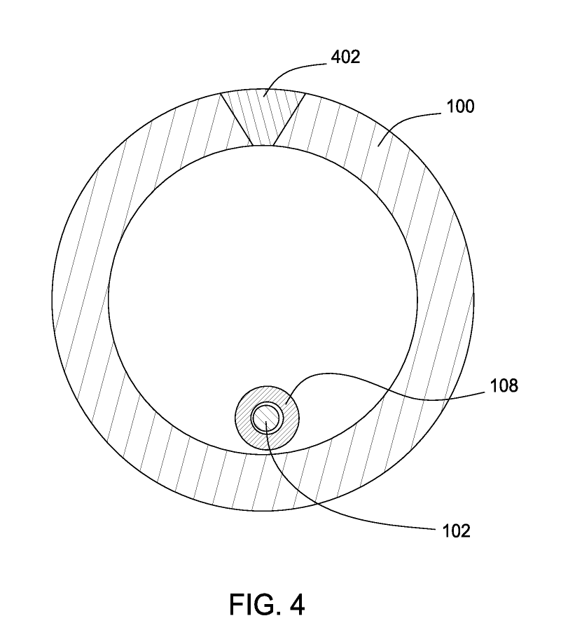

FIG. 4 illustrates an example cross-sectional view of a single optical fiber 102 in a fiber guide tube 108 in the welding zone for forming a welded armor tube having a seam 402, in accordance with one aspect of the present disclosure. For certain aspects as shown, the guide tube 108 may position the optical fiber 102 opposite from the location of the welding zone, in an effort to further prevent damage to the optical fiber during the welding process.

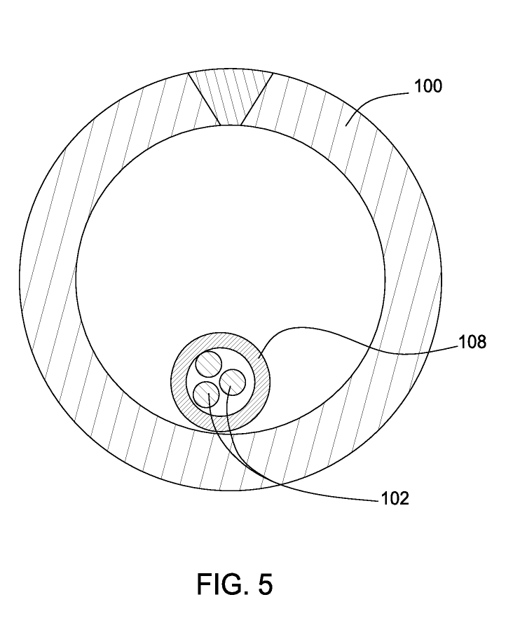

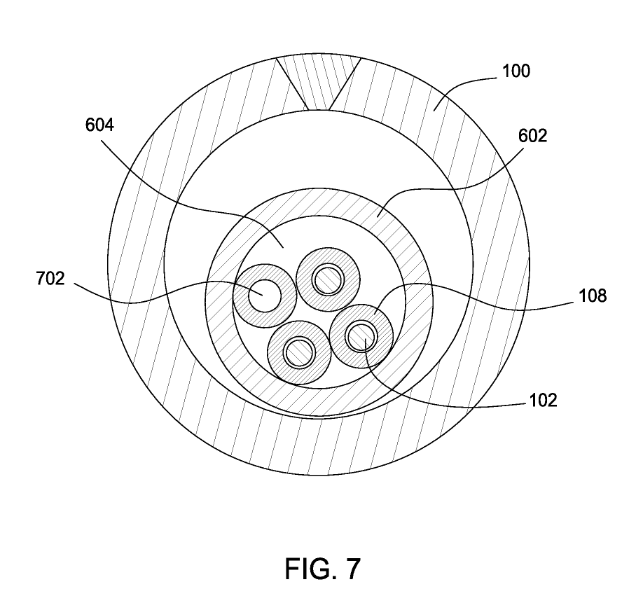

As illustrated in FIG. 5, the fiber feed/guide tube process may be made to feed multiple optical fibers at once into the armor tube welding process. This can be done with multiple fibers 102 inside each of one or more guide tubes 108 as shown, with a single optical fiber in each of multiple guide tubes, as portrayed in FIG. 7, described below, or with any combination thereof.

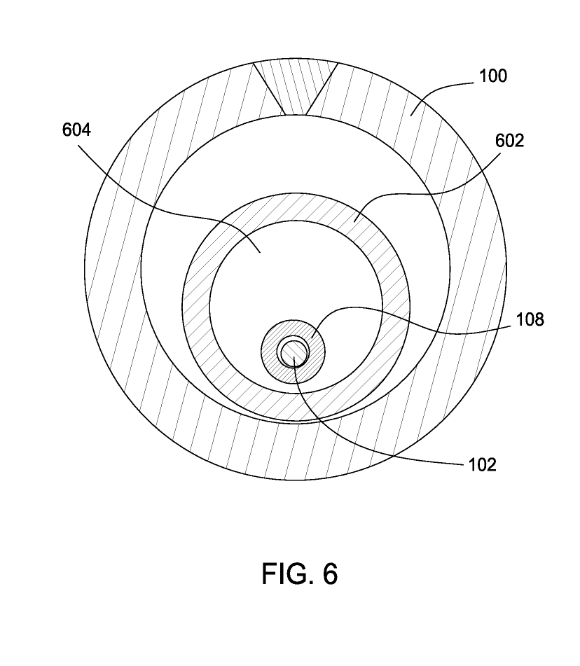

As depicted in FIG. 6, one or more additional (outer) tubes 602 may be placed around the fiber guide tube(s) 108. The space 604 between the additional tubes 602 and the fiber guide tube(s) 108 may permit fluid flow in an effort to cool the fiber(s) 102 during the welding process. For example, an inert gas purge in this space 604 may be used to provide additional heat protection for the fiber(s) in the welding zone. The space 604 may also permit flow of other materials, such as gel filling, adhesives, or lubricants.

As shown in FIG. 7, one or more additional inner guide tubes 702 may also be used for addition of gel filling, adhesives, lubricants, etc. around the optical fibers 102. These materials may be continuously or intermittently flowing when added. The additional inner guide tubes 702 may not be used for feeding optical fibers into the armor tube. The additional inner guide tubes 702 may be made of metal, ceramic, or any of various other suitable heat resistant materials.

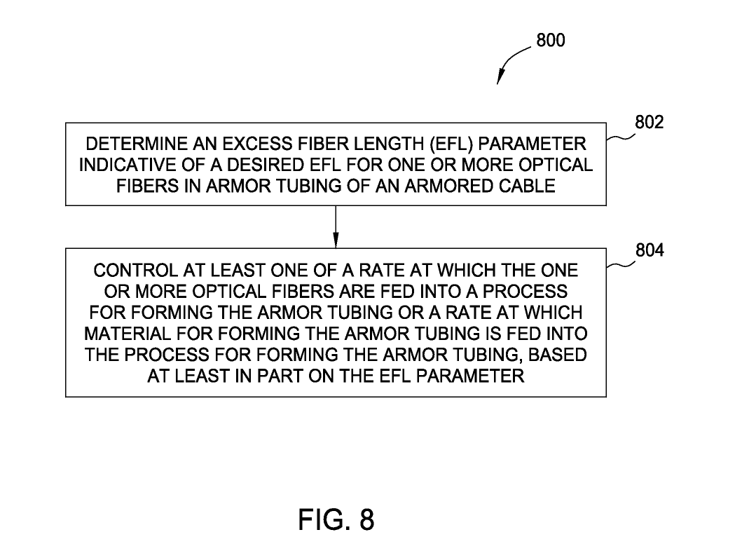

FIG. 8 is a flow diagram of example operations 800 for controlling processing rates during fabrication of an armored cable, in accordance with one aspect of the present disclosure. The operations 800 may begin, at 802, by determining an EFL parameter indicative of a desired EFL for one or more optical fibers in armor tubing of the armored cable. At 804, at least one of: (1) a rate at which the one or more optical fibers are fed into a process for forming the armor tubing; or (2) a rate at which material for forming the armor tubing is fed into the process for forming the armor tubing may be controlled, based at least in part on the EFL parameter determined at 802. The process for forming the armor tubing may involve seam welding of the armor tubing.

According to certain aspects, the controlling at 804 includes controlling the rate at which the one or more optical fibers are fed into the process as a function of the EFL parameter and the rate at which the material for forming the armor tubing is fed into the process. For certain aspects, the rate at which the one or more optical fibers are fed into the process is controlled by controlling a fiber feed device. The fiber feed device may comprise a fiber feed capstan, a banded tractor pulling/pushing mechanism, a fluid pump (e.g., a viscous gel pump), or a gas venturi.

According to certain aspects, the controlling at 804 includes controlling the rate at which the one or more optical fibers are fed into one or more inner guide tubes that protect the one or more optical fibers during the process. The inner guide tubes are not part of the final armored cable (i.e., the armored cable after the making). For certain aspects, a plurality of optical fibers are fed into a single inner guide tube. At least one outer guide tube may surround the one or more inner guide tubes. For certain aspects, at least one of the inner guide tubes is used to convey at least one of a gel filling, adhesive, lubricant, or inert gas into the armor tubing.

As described herein, new cable process techniques are provided that may allow for manufacture of armor tube cables that contain optical fibers without employing an inner tube for containing the fibers. This eliminates the traditional processing of optical fibers inside an inner tube and reduces the overall cost of the cable. The process allows manufacture of armored cables with single or multiple fibers having a uniformly distributed EFL and that may include gel fillers around the fiber(s).

The techniques presented herein may have advantages over previous solutions of inserting the optical fiber after the cable armor tube is formed, which are typically limited in the continuous length of cable which can be practically manufactured. The EFL in previous processes is not easily controlled and may not be uniformly distributed along the cable length.

While the foregoing is directed to embodiments of the present invention, other and further embodiments of the invention may be devised without departing from the basic scope thereof, and the scope thereof is determined by the claims that follow.

What is claimed is:

1. A method for making an armored cable, comprising:
determining an excess fiber length (EFL) parameter indicative of a desired EFL for one or more optical fibers in armor tubing of the armored cable; and
controlling at least one of a rate at which the one or more optical fibers are fed into a process for forming the armor tubing or a rate at which material for forming the armor tubing is fed into the process for forming the armor tubing, based at least in part on the EFL parameter.

2. The method of claim 1, wherein the controlling comprises:
controlling the rate at which the one or more optical fibers are fed into the process as a function of the EFL parameter and the rate at which the material for forming the armor tubing is fed into the process.

3. The method of claim 1, wherein the controlling comprises:
controlling the rate at which the one or more optical fibers are fed into one or more inner guide tubes that protect the one or more optical fibers during the process but are not part of the armored cable after the making.

4. The method of claim 3, wherein a plurality of optical fibers are fed into a single inner guide tube.

5. The method of claim 3, wherein at least one outer guide tube surrounds the one or more inner guide tubes.

6. The method of claim 3, wherein at least one of the inner guide tubes is used to convey at least one of a gel filling, adhesive, lubricant, or inert gas into the armor tubing.

7. The method of claim 2, wherein the rate at which the one or more optical fibers are fed into the process is controlled by controlling a fiber feed device.

8. The method of claim 7, wherein the fiber feed device comprises a tractor mechanism.

9. The method of claim 1, wherein the process involves welding of the armor tubing.

10. An apparatus for making an armored cable, comprising:
means for determining an excess fiber length (EFL) parameter indicative of a desired EFL for one or more optical fibers in armor tubing of the armored cable; and
means for controlling at least one of a rate at which the one or more optical fibers are fed into a process for forming the armor tubing or a rate at which material for forming the armor tubing is fed into the process for forming the armor tubing, based at least in part on the EFL parameter.

11. The apparatus of claim 10, wherein the means for controlling is configured to control the rate at which the one or more optical fibers are fed into the process as a function of the EFL parameter and the rate at which the material for forming the armor tubing is fed into the process.

12. The apparatus of claim 10, wherein the means for controlling is configured to control the rate at which the one or more optical fibers are fed into one or more inner guide tubes that protect the one or more optical fibers during the process but are not part of the armored cable after the making.

13. The apparatus of claim 12, wherein a plurality of optical fibers are fed into a single inner guide tube.

14. The apparatus of claim 12, wherein at least one outer guide tube surrounds the one or more inner guide tubes.

15. The apparatus of claim 12, wherein at least one of the inner guide tubes is used to convey at least one of a gel filling, adhesive, lubricant, or inert gas into the armor tubing.

16. The apparatus of claim 11, wherein the rate at which the one or more optical fibers are fed into the process is controlled by controlling a fiber feed device.

17. The apparatus of claim 16, wherein the fiber feed device comprises a gas venturi.

18. The apparatus of claim 10, wherein the process involves welding of the armor tubing.

19. An apparatus for making an armored cable, comprising:
a controller configured to:
determine an excess fiber length (EFL) parameter indicative of a desired EFL for one or more optical fibers in armor tubing of the armored cable; and
control at least one of a rate at which the one or more optical fibers are fed into a process for forming the armor tubing or a rate at which material for forming the armor tubing is fed into the process for forming the armor tubing, based at least in part on the EFL parameter.

20. The apparatus of claim 19, wherein the controller is configured to control the rate at which the one or more optical fibers are fed into one or more inner guide tubes that protect the one or more optical fibers during the process but are not part of the armored cable after the making.
